(19) United States
(12) Patent Application Publication
(10) Pub. No.: US 2011/0133067 A1
(43) Pub. Date: Jun. 9, 2011

(54) OPTICAL SENSOR HAVING A CAPILLARY TUBE AND AN OPTICAL FIBER IN THE CAPILLARY TUBE

(75) Inventors: Hitoshi Sugiyama, New Malden (GB); James McInnes, Winchester (GB); Colin Wilson, Tolworth (GB)

(73) Assignee: SCHLUMBERGER TECHNOLOGY CORPORATION, SUGAR LAND, TX (US)

(21) Appl. No.: 12/632,868

(22) Filed: Dec. 8, 2009

(51) Int. Cl. G01V 8/00; G02B 6/00

(52) U.S. Cl. 250/256; 385/13

(57) ABSTRACT

A system for use in a well includes an optical cable for positioning in the well. An optical sensor is optically coupled to the optical cable, where the optical sensor has a capillary tube and an optical fiber in the capillary tube. The capillary tube also includes a first sealed region containing a metallic material that is in liquid form at a downhole temperature in the well. A joint mechanism may attach the optical sensor to the optical cable.

### BACKGROUND

Optical sensors can be used in a well to detect various parameters associated with the well, such as temperature, pressure, and other parameters. Optical sensors can be attached to an optical cable that is deployed into the well. A benefit offered by optical sensors is that they are immune from electromagnetic interference, have relatively high sensitivity, and an interrogation system associated with the optical cable and optical sensors could be positioned relatively far away from the optical sensors. The interrogation system typically includes a light source to transmit light signals into the optical cable, and a detection mechanism to detect light returned from the optical sensors.

Conventional optical sensors can be relatively costly, since such optical sensors have to be able to withstand downhole conditions over a relatively long period of time. In a well with a large number of optical sensors, the use of costly optical sensors can substantially drive up the cost of operating the well.

### SUMMARY

Generally, according to some embodiments, a relatively simple optical sensor package is provided for reduced cost. In one embodiment, the optical sensor package can include a capillary tube and an optical fiber in the capillary tube, where the capillary tube also includes a sealed region containing a metallic material that is in liquid form at a downhole temperature in the well.

Other or alternative features will become apparent from the following description, from the drawings, and from the claims.

### BRIEF DESCRIPTION OF THE DRAWINGS

Some embodiments of the invention are described with respect to the following figures:

FIG. 1 is a schematic diagram showing an interrogation system, an optical cable, and a disposable optical sensor, according to an embodiment;

FIG. 2 is a sectional view of an optical sensor, according to an embodiment;

FIG. 3 illustrates a joint mechanism to connect the optical sensor to an optical cable, according to an embodiment;

FIGS. 4 and 5 are schematic side views of different embodiments of an optical sensor.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

As used here, the terms “above” and “below”; “up” and “down”; “upper” and “lower”; “upwardly” and “downwardly”; and other like terms indicating relative positions above or below a given point or element are used in this description to more clearly describe some embodiments of the invention. However, when applied to equipment and methods for use in wells that are deviated or horizontal, such terms may refer to a left to right, right to left, or diagonal relationship as appropriate. Additionally, in the specification and appended claims: the terms “connect”, “connection”, “connected”, “in connection with”, “connecting”, “couple”, “coupled”, “coupled with”, and “coupling” are used to mean “in direct connection with” or “in connection with via another element”; and the term “set” is used to mean “one element” or “more than one element”.

In accordance with some embodiments, a relatively low cost disposable optical sensor is provided, where the disposable optical sensor is designed to perform downhole monitoring of one or more parameters over a relatively short life (e.g., less than one month for example). The disposal optical sensor has a capillary tube that contains a sealed region in which an optical fiber is provided. In addition, a metallic material that is in liquid form at downhole temperatures in a well is provided in the sealed region. The sealed region is inside an axial bore of the capillary tube. The inner diameter of the capillary tube is sufficiently small such that surface tension between the liquid metallic material and an inner wall of the capillary tube can hold the liquid metallic material inside the capillary tube.

In some embodiments, the capillary tube can have a generally circular cross-section. Alternatively, the capillary tube can have cross-sections of other shapes, including oval, square, rectangular, pentagonal, hexagonal, and so forth.

Although reference is made to a “disposable” optical sensor that has a relatively short life, it is noted that some embodiments can also cover optical sensors designed to last a relatively long time, and that are not disposable.

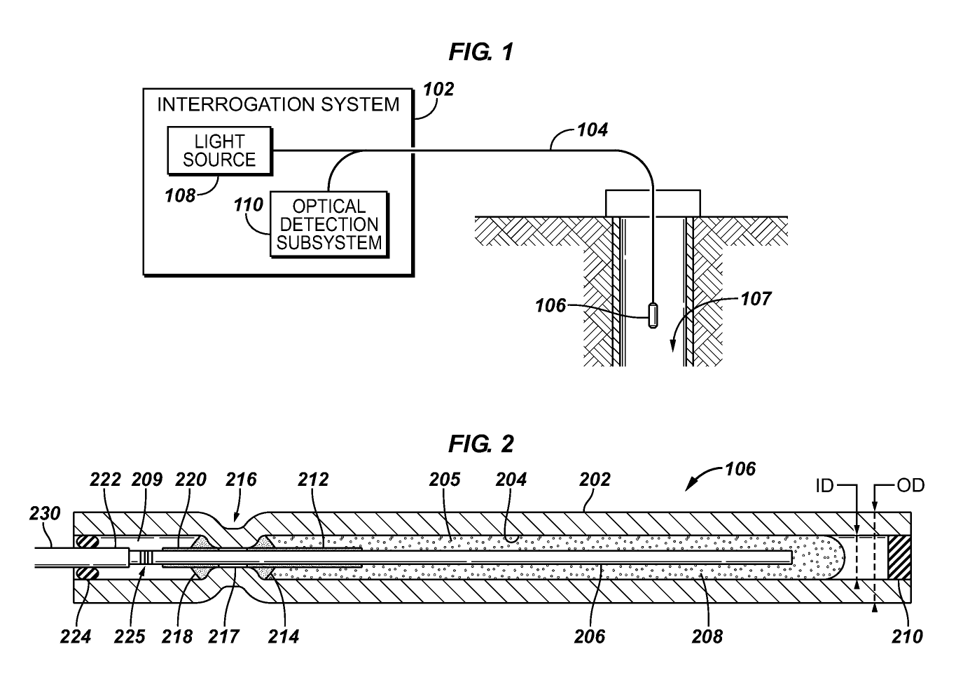

FIG. 1 illustrates an exemplary optical sensing system that includes an interrogation system 102, an optical cable 104, and an optical sensor 106 according to an embodiment. The optical sensor 106 and part of the optical cable 104 are deployed in a wellbore 107. Although just one optical sensor 106 is shown in FIG. 1, it is noted that multiple optical sensors can be provided that are each optically coupled to the optical cable 104. Optical coupling an optical sensor to the optical cable 104 means that optical signals can be communicated between the optical sensor 106 and the optical cable 104.

The interrogation system 102 includes a light source 108, such as a laser light source. The light source 108 propagates an optical signal (e.g., laser light signal) over the optical cable 104 to the optical sensor 106. Note that various intermediate optical circuits between the light source 108 and the optical cable 104 are not shown for purposes of brevity.

The optical sensor 106 is able to reflect light received over the optical cable 104 back over the optical cable 104 to the interrogation system 102. The reflected light is detectable by an optical detection subsystem 110 in the interrogation system 102. The optical detection subsystem 110 can include one or more optical detectors.

FIG. 2 shows a portion of the optical sensor 106 according to an embodiment. The optical sensor 106 includes an axial bore 204 in which an optical fiber 206 is located. The optical fiber 206 is surrounded by and encapsulated in a metallic material 208 that is in liquid form at downhole temperatures (e.g., as a non-limiting example, for downhole temperatures greater than 50° C., a material such as galinstan, with a melting point of −19° C., will be in liquid form) in the wellbore 107 (see FIG. 1). Some other non-limiting examples of metallic materials that are in liquid form at downhole temperatures are mercury and gallium. At temperatures lower than some threshold temperature (such as when the optical sensor 106 is located at the earth surface), the metallic material 208 may be in solid form.

As shown in FIG. 2, the capillary tube 202 has an outer diameter (OD) and an inner diameter (ID), where the outer diameter (OD) and inner diameter (ID) are sufficiently small to allow surface tension between the liquid metallic material 208 and the inner wall of the capillary tube 202 to hold the liquid metallic material 208 in its axial position. In other words, the surface tension between the liquid metallic material 208 and the inner wall of the capillary tube 202 allows a position of the liquid metallic material 208 to be substantially fixed in the axial direction (the longitudinal direction of the capillary tube 202) even if the optical sensor 106 is positioned vertically (such as during use in the wellbore 107).

In some embodiments, the outer diameter (OD) of the capillary tube 202 may be less than ¼ inch. In further embodiments, the outer diameter (OD) of the capillary tube 202 may be less than or equal to ⅛ inch. In yet further embodiments, the outer diameter (OD) of the capillary tube 202 may be less than or equal to 1/16 inch.

A plug 210 is provided at one end of the capillary tube 202 to isolate the inside of the capillary tube 202 from external well fluids. In one example, the plug 210 can be a silicone grease cap. In other implementations, other types of plugs can be employed.

The optical fiber 206 extends longitudinally inside the axial bore 204 of the capillary tube 202 through a narrowed section 216 of the capillary tube 202. The narrowed section 216 has a reduced outer diameter and a reduced inner diameter when compared to the remainder of the capillary tube 202.

The narrowed section 216 can be formed by using a swaging tool that engages the outer surface of the capillary tube 202 and is rotated to compress the capillary tube 202 to form the narrowed section 216. In other implementations, other techniques of forming the narrowed section 216 can be employed. In another embodiment, the capillary tube 202 can be formed of multiple sections, with welding used to attach the different sections together, including the narrowed section 216 and the remaining sections of the capillary tube 202.

In FIG. 2, it is shown that both the inner diameter and the outer diameter of the narrowed section 216 are smaller than the corresponding inner diameter and outer diameter of the remaining sections of the capillary tube 202. In a different implementation, the outer diameter of the narrowed section 216 can remain consistent with the outer diameter of the remaining sections of the capillary tube 202, while the inner diameter of the narrowed section 216 is reduced with respect to the inner diameter of the remaining sections of the capillary tube 202.

On the two sides of the narrowed section 216 of the capillary tube 202 in an axial direction, the optical fiber 206 is provided with first and second coating sections 212 and 220, respectively. A gap may be provided between the coating sections 212 and 220 in the narrowed section 216 of the capillary tube 202. The first coating section 212 allows a hermetic seal 214 to be formed between the inner wall of the capillary tube 202 and the outer surface of the first coating section 212.

The hermetic seal 214 shown in FIG. 2 is provided at a location adjacent a first side of the narrowed section 216. In one implementation, the hermetic seal 214 can be a glass hermetic seal. The hermetic seal 214 and the plug 210 together form a first sealed region 205 between the hermetic seal 214 and the plug 210. A first portion of the optical fiber 206 is located in this first sealed region 205.

As further shown in FIG. 2, a second hermetic seal 218 may be formed on the other side of the narrowed section 216, where the second hermetic seal 218 seals against the inner surface of the capillary tube 202 and an outer surface of the second coating section 220 around the optical fiber 206.

In the narrowed section 216 of the capillary tube 202, a glue layer 217 is provided between the inner wall of the narrowed section 216 and the outer surface of the optical fiber 206 portion inside the narrowed section 216. The glue layer 217 fixes the optical fiber 206 inside the capillary tube 206 (to avoid axial movement of the optical fiber 206).

As further shown in FIG. 2, a third coating section 222 may be provided around another portion of the optical fiber 206. A sealing member 224 (such as an O-ring seal) may be provided between the inner surface of the capillary tube 202 and the outer surface of the third coating section 222. The sealing member 224 and the hermetic seal 218 define a second sealed region 209 inside the capillary tube 202 that is isolated from the first sealed region 205 defined between the hermetic seal 214 and the plug 210.

As shown in FIG. 2, an optical grating 225 is formed on a section of the optical fiber 206 portion in the second sealed region 209. The optical grating 225 causes reflection of light that is transmitted into the optical fiber (such as from the light source 108 via the optical cable 104 shown in FIG. 1). The optical grating 225 is used for sensing temperature in the wellbore 107. A benefit of positioning the optical grating 225 in the second sealed region is that the second sealed region is fluidically isolated from the first sealed region 205 such that pressure in the first sealed region 205 does not affect the temperature measurement made by the optical grating 225 in the second sealed region 209.

Note that the first sealed region 205 of the capillary tube 202 has a relatively long length, as compared to the second sealed region 209, such that the first sealed region 205 is subjected to greater pressure forces. The optical fiber portion inside the first sealed region 205 is correspondingly also subjected to greater pressure forces. Accordingly, the optical fiber portion inside the first sealed region 205 is relatively sensitive to pressure changes in the well that are applied to the capillary tube 202 and transmitted through the wall of the capillary tube 202 to the first sealed region 205.

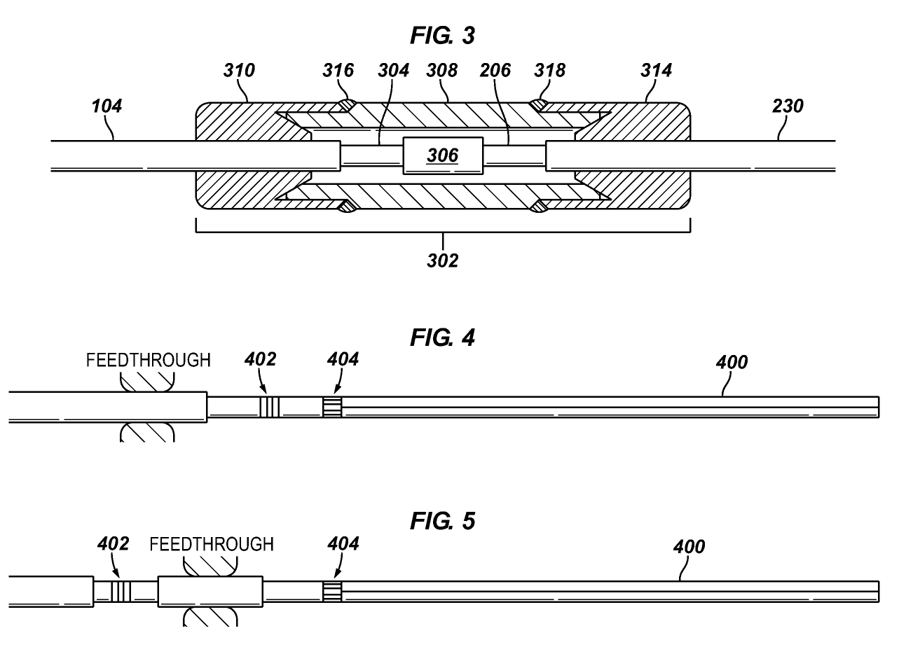

FIG. 3 shows an embodiment of a joint mechanism 302 that may be used to connect the optical cable 104 of FIG. 1 to a cable 230 that contains the optical fiber 206 of FIG. 2. The cable 230 may be referred to as the “optical sensor cable 230.” A fusion splice 306 in the joint mechanism 302 connects the optical fiber 206 of the optical sensor cable 230 and an optical fiber 304 in the optical cable 104.

As further shown in FIG. 3, the joint mechanism 304 may have a housing section 308 and two end caps 310 and 312 attached to the housing section 308 for respectively providing sealing engagement between the housing section 308 and the optical cable 104 and optical sensor cable 230.

In the embodiment of FIG. 3, the end cap 310 and the housing section 308 may be coupled together by a weld connection 316, and the housing section 308 and the end cap 314 may be coupled together by a weld connection 318.

FIGS. 4 and 5 illustrate two different embodiments of an optical sensor. The FIG. 4 embodiment shows both an optical grating 402 (for temperature measurement) and a polarizer 404 (for pressure measurement) formed on an optical fiber 400 provided on the same side of a feed through location (which corresponds to the narrowed section 216 shown in FIG. 2). The polarizer 404 is used to convert un-polarized or mixed-polarization light into light having a single polarization state.

In the FIG. 5 embodiment, the optical grating 402 and polarizer 404 are provided on different sides of the feed through location. The FIG. 5 embodiment is similar to the FIG. 2 embodiment in which the pressure sensor (e.g., the optical fiber 206 portion inside the first sealed region 205) is on a different side of the narrowed section 216 than the temperature sensor (e.g., the optical grating 225 inside the second sealed region 209).

As noted above, the capillary tube 202 of the optical sensor according to some embodiments may have a relatively small outer diameter, e.g., less than or equal to ⅛ or 1/16 inch. With such a small outer profile, it is possible to pump the optical sensor downhole through a control line, for example.

Also, by employing a capillary tube 202 having an inner diameter that is sufficiently small such that tension between the liquid metallic material and the inner surface of the capillary tube 202 is able to hold the position of the liquid metallic material, an intricate or complex sealing mechanism does not have to be provided between the inner axial bore of the capillary tube and the outside, which helps to reduce cost. Instead, a simple plug 210 formed of a silicone grease cap, for example, can be used to provide the seal.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A system for use in a well, comprising:
an optical cable for positioning in the well;
an optical sensor optically coupled to the optical cable, wherein the optical sensor has a capillary tube and an optical fiber in the capillary tube, wherein the capillary tube also includes a first sealed region containing a metallic material that is in liquid form at a downhole temperature in the well; and
a joint mechanism to attach the optical sensor to the optical cable.

2. The system of claim 1, wherein the capillary tube has an outer diameter less than ¼ inch.

3. The system of claim 1, wherein the capillary tube has an outer diameter less than or equal to ⅛ inch.

4. The system of claim 1, wherein the capillary tube has an outer diameter less than or equal to 1/16 inch.

5. The system of claim 1, wherein the metallic material is selected from the group consisting of galinstan, mercury, and gallium.

6. The system of claim 1, wherein the capillary tube has a narrowed section having a reduced inner diameter, and a first sealing mechanism adjacent the narrowed section to at least partially define the first sealed region.

7. The system of claim 6, wherein the capillary tube further comprises a second sealing mechanism spaced apart from the first sealing mechanism to at least partially define a second sealed region.

8. The system of claim 6, wherein the optical fiber has a portion with a coating, and wherein the first sealing mechanism is a hermetic seal between and in contact with an inner wall of the capillary tube and an outer surface of the coating.

9. The system of claim 6, further comprising an optical grating in the capillary tube, wherein the first sealing mechanism is between the optical grating and a portion of the optical fiber in the first sealed region.

10. The system of claim 9, wherein the optical grating is in a second sealed region within the capillary tube, wherein the second sealed region is fluidically isolated from the first sealed region.

11. The system of claim 10, wherein the optical grating is used to perform temperature measurement, and the portion of the optical fiber in the first sealed region is used to perform pressure measurement.

12. The system of claim 11, wherein the first sealed region is longer in length than the second sealed region.

13. The system of claim 6, further comprising an optical grating formed on the optical fiber, wherein the optical grating is in the first sealed region.

14. A method for measuring one or more parameters of a well, comprising:
deploying an optical sensor into the well, wherein the optical sensor has a capillary tube containing a portion of an optical fiber in a first sealed region of the capillary tube, and wherein the first sealed region contains a liquid metallic material encapsulating the portion of the optical fiber; and
sending a light signal to the optical sensor.

15. The method of claim 14, further comprising attaching the optical sensor to an optical cable, wherein the optical sensor is deployed into the well with the optical cable, and wherein the light signal is sent through the optical cable to the optical sensor.

16. The method of claim 14, further comprising providing a second sealed region in the capillary tube, wherein the second sealed region includes a temperature sensing element, and the portion of the optical fiber in the first sealed region includes a pressure sensing element.

17. The method of claim 14, wherein the capillary tube has an outer diameter less than or equal to ⅛ inch.

18. The method of claim 14, wherein the capillary tube has an outer diameter less than or equal to 1/16 inch.

19. An optical sensor for measuring at least one parameter of a well, comprising:
a capillary tube having an axial bore and a first sealed region;
an optical fiber having a portion in the first sealed region; and
a metallic material encapsulating the portion of the optical fiber, wherein the metallic material is in liquid form at a downhole temperature in the well.

20. The optical sensor of claim 19, further comprising a silicone grease cap to plug one end of the cap, wherein the first sealed region is partially defined by the silicone grease cap.

21. The optical sensor of claim 19, wherein the capillary tube has a second sealed region fluidically isolated from the first sealed region, wherein another portion of the optical fiber is provided in the second sealed region.

22. The optical sensor of claim 21, wherein the portion of the optical fiber in the second sealed region is used to provide temperature measurement, and the portion of the optical fiber in the first sealed region is used to provide pressure measurement.
